(19) United States
(12) Patent Application Publication
(10) Pub. No.: US 2025/0267469 A1
(43) Pub. Date: Aug. 21, 2025

(54) DYNAMIC ANTENNA DEVICE RECONFIGURATION FOR SPECTRUM ACCESS REQUESTS FOLLOWING INCUMBENT-BASED SUSPENSION

(71) Applicant: Charter Communications Operating, LLC, St. Louis, MO (US)

(72) Inventors: Saran Khalid, Denver, CO (US); Mohammedyusuf Shaikh, Aurora, CO (US); Perwaiz Akhtar, Aurora, CO (US); Mirza Kashif Baig Mirza Ismail Baig, Brampton (CA)

(21) Appl. No.: 18/583,511

(22) Filed: Feb. 21, 2024

(51) Int. Cl. H04W 16/14; H04W 16/02

(52) U.S. Cl. CPC H04W 16/14; H04W 16/02

(57) ABSTRACT

A spectrum access grant for a non-incumbent network entity is determined to be revoked by a Spectrum Access System (SAS) responsive to spectrum utilization by an incumbent network entity. The spectrum access grant is indicative of a first antenna configuration for one or more antenna devices of the non-incumbent network entity to communicate via a wireless network. A second antenna configuration is determined for the one or more antenna devices to communicate via the wireless network. The second antenna configuration is predicted to cause less interference between the non-incumbent network entity and the incumbent network entity. A non-incumbent spectrum access request is provided to the SAS including a request for access to the second antenna configuration for the antenna devices.

### BACKGROUND

Some wireless networks, or particular regions of wireless spectrum, have introduced tiered access frameworks in which some entities have higher access priority than others. For example, the Citizens Broadband Radio Service (CBRS) refers to a shared region of wireless spectrum that allows different entities to utilize the same frequency bands dynamically. The Federal Communications Commission (FCC), which manages aspects of the CBRS, has introduced three tiers of access for the CBRS: incumbent entities, Priority Access License (PAL) holding entities, and General Authorized Access (GAA) entities. CBRS access is tiered so that “non-priority” entities (e.g., businesses, network service providers, etc.) do not interfere with “priority” entities. For example, in response to a CBRS access request from an incumbent entity, CBRS access may be revoked from non-incumbent entities that are likely to cause interference with the incumbent entity.

Management of access to such wireless networks is often handled by a managing entity, such as a Spectrum Access System (SAS). To follow the previous example, the SAS may receive the CBRS access request from the incumbent entity, and in response, identify and revoke access grants from the non-incumbent entities likely to cause interference. The SAS can identify non-incumbent entities likely to cause interference based on the direction of antenna beams generated by the non-incumbent entities. In this manner, tiered access can facilitate public use of regions of spectrum previously restricted for governmental use while ensuring a lack of interference for governmental entities.

### SUMMARY

A non-incumbent network entity can detect that a spectrum access grant for antenna device(s) of the non-incumbent network entity has been revoked by a Spectrum Access System (SAS). The entity can determine a second antenna configuration for the antenna device(s) that is predicted to cause less interference between the non-incumbent network entity and an incumbent network entity. The non-incumbent network entity can provide a non-incumbent spectrum access request including the second configuration to the SAS. In response, the SAS can either approve the non-incumbent spectrum access request, and the non-incumbent network entity can configure the antenna device(s) with the second antenna configuration.

In one implementation, a method is provided. The method includes determining, by a computing system comprising one or more computing devices, that a spectrum access grant for a non-incumbent network entity has been revoked by a SAS responsive to spectrum utilization by an incumbent network entity, wherein the spectrum access grant is indicative of a first antenna configuration for one or more antenna devices of the non-incumbent network entity to communicate via a wireless network. The method includes determining, by the computing system, a second antenna configuration for the one or more antenna devices to communicate via the wireless network, wherein the second antenna configuration is predicted to cause less interference between the non-incumbent network entity and the incumbent network entity than the first antenna configuration. The method includes providing, by the computing system, a non-incumbent spectrum access request to the SAS, wherein the non-incumbent spectrum access request comprises a request for access to the second antenna configuration for the one or more antenna devices to communicate via the wireless network.

In another implementation, a computing system is provided. The computing system includes a memory and one or more processor devices. The one or more processor devices are configured to determine that a spectrum access grant for a non-incumbent network entity has been revoked by a SAS responsive to spectrum utilization by an incumbent network entity, wherein the spectrum access grant is indicative of a first antenna configuration for a plurality of antenna devices of the non-incumbent network entity to communicate via a wireless network. The one or more processor devices are configured to process the first antenna configuration with a machine-learned antenna configuration model to obtain a second antenna configuration for the plurality of antenna devices to communicate via the wireless network, wherein the second antenna configuration is more likely to be granted by the SAS than the first antenna configuration. The one or more processor devices are configured to provide a non-incumbent spectrum access request to the SAS, wherein the non-incumbent spectrum access request comprises a request for access to the second antenna configuration for the plurality of antenna devices. The one or more processor devices are configured to, responsive to receiving information indicating that the SAS has granted the non-incumbent spectrum access request, apply the second antenna configuration to the plurality of antenna devices.

In another implementation, a non-transitory computer-readable storage medium is provided. The non-transitory computer-readable storage medium includes executable instructions to cause a processor device to determine that a spectrum access grant for a non-incumbent network entity has been revoked by a SAS responsive to spectrum utilization by an incumbent network entity, wherein the spectrum access grant is indicative of a first antenna configuration for one or more antenna devices of the non-incumbent network entity to communicate via a wireless network. The instructions further cause the processor device to determine a second antenna configuration for the one or more antenna devices to communicate via the wireless network, wherein the second antenna configuration is predicted to cause less interference between the non-incumbent network entity and the incumbent network entity than the first antenna configuration. The instructions further cause the processor device to provide a non-incumbent spectrum access request to the SAS, wherein the non-incumbent spectrum access request comprises a request for access to the second antenna configuration for the one or more antenna devices to communicate via the wireless network.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1A is a block diagram of an environment suitable for implementing dynamic antenna device reconfiguration for spectrum access requests following incumbent-based suspension according to some implementations of the present disclosure.

FIG. 1B is a block diagram of an environment suitable for implementing bulk antenna device reconfiguration following bulk incumbent-based suspension according to some implementations of the present disclosure.

FIG. 2A is a communication flow diagram for communication between network entities and a SAS for implementing dynamic antenna device reconfiguration for spectrum access requests according to some implementations of the present disclosure.

FIG. 2B is a communication flow diagram for performing configuration reversion for radio devices of a non-incumbent network entity following cessation of spectrum utilization by an incumbent network entity according to some implementations of the present disclosure.

FIG. 3 depicts a communication environment in which configurations for antenna devices are dynamically reconfigured to reduce predicted interference according to some implementations of the present disclosure.

FIG. 4 depicts a flow chart diagram of an example method to perform dynamic antenna device reconfiguration for spectrum access requests following incumbent-based suspension according to some implementations of the present disclosure.

FIG. 5 is a block diagram of the non-incumbent network entity suitable for implementing examples according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

As described previously, some wireless networks, or particular regions of wireless spectrum, have introduced tiered access frameworks in which some users have higher access priority than others. For example, the Citizens Broadband Radio Service (CBRS) refers to a shared region of wireless spectrum that allows different entities to utilize the same frequency bands dynamically. The Federal Communications Commission (FCC), which manages aspects of the CBRS, has introduced three tiers of access for the CBRS: incumbent entities, Priority Access License (PAL) holding entities, and General Authorized Access (GAA) entities. CBRS access is tiered so that “non-priority” entities (e.g., businesses, network service providers, etc.) do not interfere with “priority” entities (e.g., federal entities, etc.). For example, if an incumbent entity requests access to the CBRS, CBRS access may then be revoked from non-incumbent entities that are likely to cause interference with the incumbent entity.

Fifth-Generation (5G) New Radio (NR) wireless networks have generally required a greater number of radio devices to implement than prior network architectures (e.g., Fourth Generation (4G) Long-term Evolution (LTE), etc.), and it is likely that this trend with continue with subsequent network architecture generations. Some non-incumbent entities are network service providers that implement radio devices to provide 5G wireless networks. As such, the likelihood of interference between incumbent entities and non-incumbent entities has increased as network service providers have implemented greater numbers of 5G radio devices.

As described herein, an “incumbent” entity generally refers to an entity, or device(s) associated with an entity, that are assigned access priority to a wireless network (or region of spectrum) that is greater than the access priority assigned to “non-incumbent” entities. In other words, in scenarios where network resources are insufficient for both incumbent and non-incumbent entities, resource access will be revoked from non-incumbent entities and granted to incumbent entities. Examples of incumbent entities can include governmental agencies, militaries, defense contractors, foreign entities, airlines, public transportation, etc. Conversely, examples of non-incumbent entities can include commercial entities (e.g., network service providers), some public services, etc. However, it should be noted that an incumbent entity and a non-incumbent entity can, in some instances, be the same or similar type of entity. For example, an incumbent entity may refer to a commercial entity subscribed to network services with greater access priority than that of network services subscribed to by a non-incumbent entity.

Management of access to tiered wireless networks is often handled by a managing entity, such as a Spectrum Access System (SAS). In response to an access request from an incumbent entity, the SAS can identify and revoke access grants from non-incumbent entities likely to interfere with the incumbent entity. The SAS can identify non-incumbent entities likely to cause interference based on the configuration of antenna devices associated with the non-incumbent entity. In this manner, tiered access can facilitate public use of regions of spectrum previously restricted for governmental use while ensuring a lack of interference for governmental entities.

For example, assume that an incumbent network entity (e.g., a transportation entity, a managing entity, etc.) located within a Dynamic Protection Area (DPA) (e.g., the coast of a major city, etc.) begins to utilize spectrum, or a particular region of spectrum, to communicate. Environmental Sensing Capability (ESC) devices located in or around the DPA can detect spectrum utilization by the incumbent network entity. The ESC devices can inform the SAS of the detected spectrum utilization. In response, the SAS can revoke spectrum access grants previously provided to local non-incumbent network entities (e.g., non-incumbent network entities located within a certain range of the incumbent network entity, etc.).

In particular, the SAS can revoke a spectrum access grant from specific antenna device(s), and/or radio devices that each include multiple antenna devices. For example, assume the non-incumbent entity is associated with a radio device that includes four antenna devices collectively signaling in a 360° area (e.g., north, south, east, and west). If the incumbent entity is located southwest of the radio device, the SAS may revoke spectrum access grants from two of the antenna devices that radiate towards the incumbent entity (e.g., an antenna device radiating south and an antenna device radiating west). Alternatively, if the SAS is unaware of the directionality of the antenna devices, the SAS may instead revoke spectrum access grants from all four of the antenna devices.

Without a spectrum access grant, an antenna device cannot be used to implement a wireless network. In turn, revocation of spectrum access grants due to incumbent entity activity can substantially decrease network performance for wireless networks implemented by non-incumbent entities. This decrease in network performance can be mitigated by decreasing the duration over which the spectrum access grant is revoked. However, the SAS will generally deny subsequent spectrum access requests likely to cause interference with the incumbent entity. As such, a technique to dynamically predict antenna configurations (and corresponding coverage patterns) that are less likely to cause interference would substantially increase network performance.

Accordingly, implementations of the present disclosure propose dynamic antenna device reconfiguration for spectrum access requests following incumbent-based suspension. For example, assume that access to a wireless network is managed by a SAS, and that the SAS has granted a spectrum access grant to a non-incumbent network entity (e.g., a radio device, an antenna device, etc.). The spectrum access grant for the non-incumbent network entity can indicate a first antenna configuration for antenna device(s) of the entity. The first antenna configuration can describe antenna configuration parameter(s) for communication via the wireless network managed by the SAS (e.g., azimuth, beam height, beam width, etc.).

An incumbent entity can begin to utilize spectrum, or a region of spectrum, that is managed by the SAS. This utilization can be detected by a network of ESC devices. Once detected, the ESC devices can inform the SAS of the spectrum utilization by the incumbent network entity. In response to the request from the incumbent network entity, the SAS can revoke the spectrum access grant from the antenna device(s) of the non-incumbent network entity to reduce the probability that the incumbent entity will suffer from interference. For example, if the antenna device(s) of the non-incumbent network entity radiate towards the location of the incumbent entity, the SAS may revoke the spectrum access grant for the non-incumbent network entity.

A computing system associated with the non-incumbent network entity can detect that the spectrum access grant has been revoked by the SAS. For example, upon revoking the spectrum access grant from the non-incumbent network entity, the SAS can provide information indicating revocation of the spectrum access grant to the computing system. Alternatively, the computing system may be informed by the antenna device(s) or device(s) associated with the antenna device(s) (e.g., radio device(s).

In response to detecting revocation of the spectrum access grant, the computing system can determine a second antenna configuration for the antenna device(s). The second antenna configuration can be predicted to cause less interference between the non-incumbent network entity and the incumbent network entity than the first antenna configuration. For example, assume that, for one of the antenna device(s), the first antenna configuration describes an omni-directional radiation pattern for the antenna that can radiate in all directions (e.g., north, south, east, west). If the incumbent network entity is located south of the antenna device, the second antenna configuration can describe a second radiation pattern that radiates towards the north, east, and west, but does not radiate towards the south. In some implementations, the second antenna configuration can be determined with a machine-learned model. More specifically, a machine-learned antenna configuration model can be trained based on prior spectrum access requests and corresponding responses from the SAS.

The computing system can provide a non-incumbent spectrum access request to the SAS. The non-incumbent spectrum access request can include a request for access to the second antenna configuration for the antenna device(s) to communicate via the wireless network. In response, the SAS can either approve or reject the non-incumbent spectrum access request. If accepted, the computing system can configure (or cause configuration of) the antenna device(s) with the second antenna configuration.

Alternatively, if the non-incumbent spectrum access request is denied, the computing system can provide a second non-incumbent spectrum access request to the SAS for a third antenna configuration that provides coverage of a different geographic area than the second antenna configuration. For example, assume that the incumbent network entity is south and slightly to the west of the antenna device(s), and that the second antenna configuration describes a radiation pattern that radiates towards the north, east, and west, but does not radiate towards the south. To increase the likelihood that the third antenna configuration is accepted by the SAS, the third antenna configuration can specify a more conservative radiation pattern that radiates towards the north and east, but does not radiate towards the south or the west. In this manner, the computing system can iteratively provide more conservative antenna configurations until accepted by the SAS, thus ensuring rapid re-configuration of antenna devices to minimize service disruptions.

Implementations of the present disclosure provide a number of technical effects and benefits. As one example technical effect and benefit, implementations described herein can substantially increase network capacity by more efficiently utilizing existing network resources. Specifically, in networks with tiered access, a spectrum request from an incumbent network entity can cause a SAS to revoke spectrum access from non-incumbent network entities. In turn, networks implemented by non-incumbent entities such as network service providers can suffer severe performance degradation due to revocation of spectrum access. However, by dynamically modifying antenna configurations to reduce predicted interference with the incumbent entity, implementations described herein can rapidly identify an antenna configuration that is acceptable to the SAS, thus quickly and efficiently restoring spectrum access to the non-incumbent network entity.

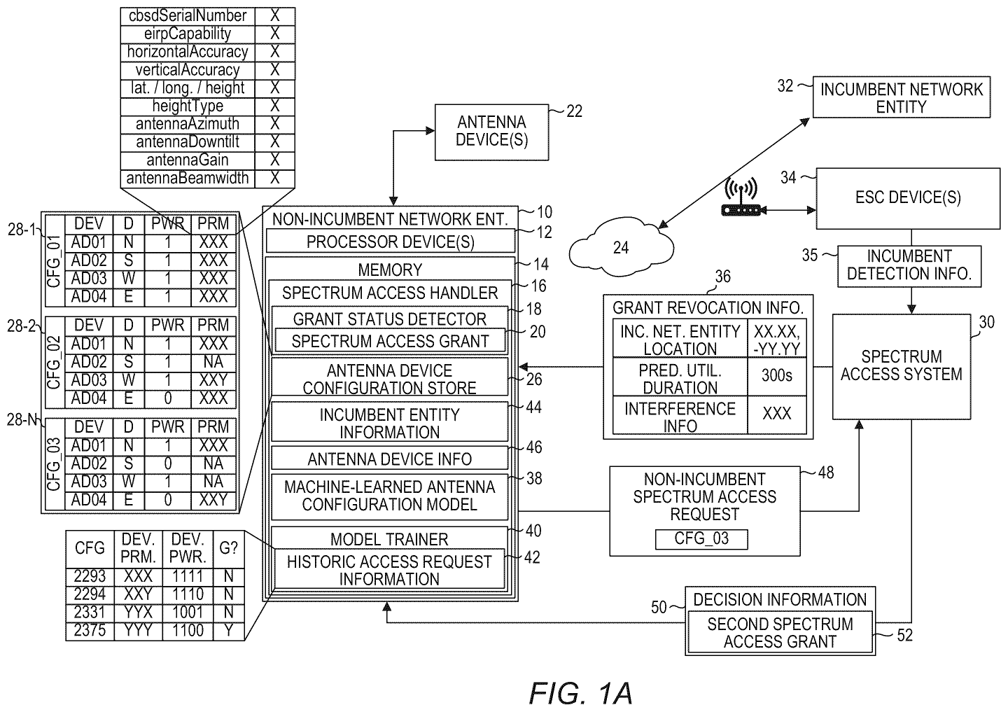

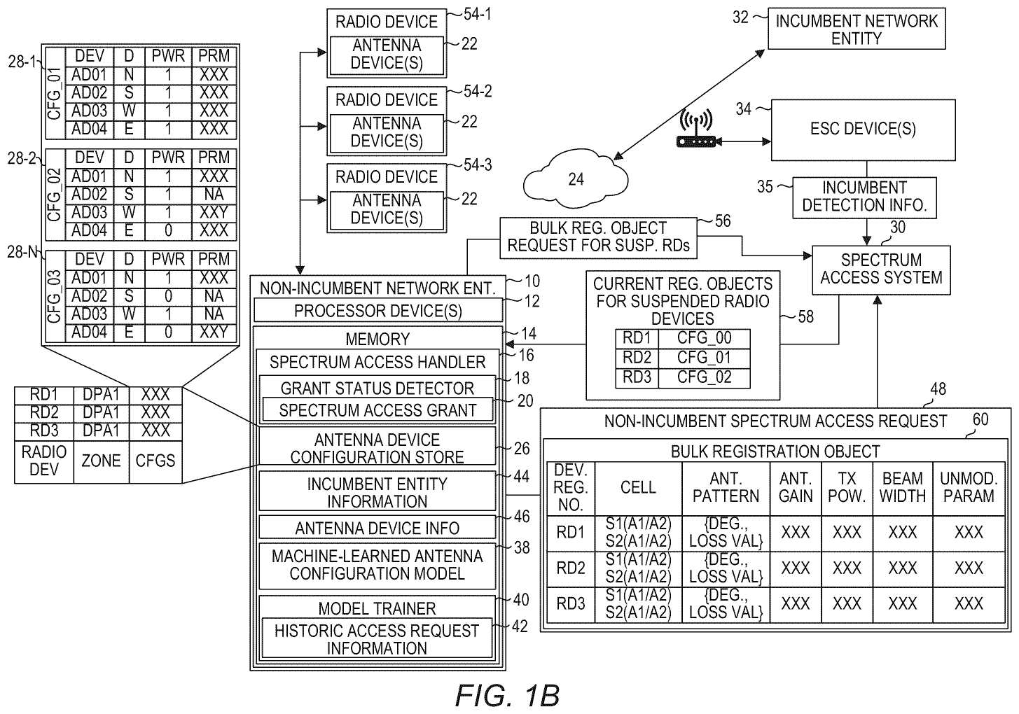

FIG. 1A is a block diagram of an environment suitable for implementing dynamic antenna device reconfiguration for spectrum access requests following incumbent-based suspension according to some implementations of the present disclosure. In some implementations, a non-incumbent network entity 10 includes processor device(s) 12 and memory 14. In some implementations, the non-incumbent network entity 10 may be a computing system that includes multiple computing devices. Alternatively, in some implementations, the non-incumbent network entity 10 may be one or more computing devices within a computing environment that includes multiple distributed devices and/or systems. Similarly, the processor device(s) 12 may include any computing or electronic device capable of executing software instructions to implement the functionality described herein.

The following description refers to both “non-incumbent” network entities and “incumbent” network entities. As described herein, a network entity refers to any type or manner of entity that requests access to a tiered-access network or a tiered-access region of frequency spectrum. In particular, an incumbent entity refers to an entity assigned to an access tier that is greater than the access tier to which non-incumbent entities are assigned. For example, spectrum utilization by an incumbent entity would be prioritized over similar utilization by a non-incumbent network entity. A “network entity,” as described herein, can refer to network service providers (e.g., internet service providers, wireless telephony service providers, geolocation services, etc.), governmental organizations (e.g., first responders, etc.), medical personnel, private organizations, businesses, individuals, etc.).

It should be noted that “network entity” (e.g., the non-incumbent network entity 10) may be used interchangeably throughout to refer to either a network entity or device(s) associated with a network entity. Specifically, to demonstrate various implementations of the present disclosure more clearly, the non-incumbent network entity 10 is depicted as a computing system and will be referred to interchangeably as both a computing system and non-incumbent network entity throughout. However, the non-incumbent network entity 10 can be, or otherwise include, a variety of computing device(s) and/or network-specific device(s). Specifically, in some implementations, the non-incumbent network entity 10 can be, or otherwise include, a network node. The network node can perform various functions, and can include or otherwise implement various network functions. The network node can perform various functions, and can include or otherwise implement various network functions. For example, the network node may implement a SAS. Alternatively, the network node may implement services for communicating with the SAS.

Alternatively, in some implementations, the non-incumbent network entity 10 can be a computing device or system that is communicatively coupled to a network node (e.g., via existing wired or wireless network infrastructure). For example, the non-incumbent network entity 10 can be a distributed network of computing device(s) and/or system(s) that collectively implement various wireless networking services of an Internet Service Provider (ISP).

The memory 14 can be or otherwise include any device(s) capable of storing data, including, but not limited to, volatile memory (random access memory, etc.), non-volatile memory, storage device(s) (e.g., hard drive(s), solid state drive(s), etc.). In particular, the memory 14 can include a containerized unit of software instructions (i.e., a “packaged container”). The containerized unit of software instructions can collectively form a container that has been packaged using any type or manner of containerization technique.

The containerized unit of software instructions can include one or more applications, and can further implement any software or hardware necessary for execution of the containerized unit of software instructions within any type or manner of computing environment. For example, the containerized unit of software instructions can include software instructions that contain or otherwise implement all components necessary for process isolation in any environment (e.g., the application, dependencies, configuration files, libraries, relevant binaries, etc.).

The memory 14 can include a spectrum access handler 16. The spectrum access handler 16 can implement functionality for requesting, monitoring, accepting, and configuring spectrum access for the non-incumbent network entity 10 and/or any other device(s) associated with the non-incumbent network entity. For example, the non-incumbent network entity 10 associated with the computing system can possess multiple radio devices that each include antenna devices. The spectrum access handler 16 can handle spectrum access for the antenna devices of each of the radio devices.

To do so, the spectrum access handler 16 can include a grant status detector 18. The grant status detector 18 can monitor the status of a spectrum access grant 20 for antenna device(s) 22 that are associated with the non-incumbent network entity. More specifically, the non-incumbent network entity 10 can include antenna device(s) 22. The antenna device(s) 22 can transmit or receive information via a network 24. The network 24 can be any type of network (e.g., wireless network, wired network, laser-based network, satellite network, etc.) or region of frequency spectrum utilized by a network.

In some implementations, the antenna device(s) 22 can be a plurality of antennas included in a single radio device. Additionally, or alternatively, in some implementations, the antenna device(s) 22 can refer to a set of radio devices distributed across a geographic area. For example, the antenna device(s) 22 can be distributed by the non-incumbent network entity 10 such that the antenna device(s) 22 can collectively implement coverage for subscribers to high-speed wireless networking services implemented by the non-incumbent network entity, such as 5G NR networks.

In some implementations, the network 24 can be, utilize, or otherwise implement a Citizen Broadband Radio Service (CBRS) network or a region of frequency spectrum associated with a CBRS (e.g., a 3.5 GHz band from 3550-3700 MHZ). Alternatively, the network 24 can refer to some other type or manner of tiered access network.

The antenna device(s) 22 can be configured to communicate via the network 24 based on an antenna configuration. The spectrum access handler 16 can include an antenna device configuration store 26. The antenna device configuration store 26 can store prior and/or current antenna configuration(s) 28-1 28-N (generally, antenna configurations 28) applied to the antenna device(s) 22. The antenna configurations 28 can specify values for parameters that control various characteristics of the antenna device(s) 22, such as Equivalent Isotropic Radiated Power (EIRP), azimuth, gain, beam width, etc. In addition, the antenna configurations 28 can describe various characteristics of the antenna device(s) 22, such as deployment height, deployment location (e.g., latitude and longitude, etc.), deployment angle, deployment type (e.g., indoor or outdoor deployment), etc. In particular, the antenna configurations 28 can control the direction and shape of beams formed by the antenna device(s) 22.

The antenna characteristics described by the antenna configurations 28 may be either mutable or immutable based on the type of antenna device described. For example, if one of the antenna device(s) 22 is mobile, the latitude and longitude of the antenna device may be iteratively updated based on the location of the antenna device. For another example, if the antenna device(s) is motorized in some manner (e.g., for dynamic adjustment of height or angle), those corresponding characteristics can be iteratively updated.

Additionally, or alternatively, in some implementations, the antenna configurations 28 can deactivate a particular antenna device of multiple antenna devices based on the direction in which the antenna device communicates. Directional activation and deactivation of antenna device(s) will be discussed in greater detail further in the specification.

Prior to configuring the antenna device(s) 22 with the antenna configurations 28, the non-incumbent network entity 10 receives the spectrum access grant 20 from a Spectrum Access System (SAS) 30. The SAS 30 can be a network function, device, etc. that manages access to the network 24, or a particular region of frequency spectrum within the network 24. To do so, the SAS can deny utilization of the network 24 to network entities that do not possess a spectrum access grant (e.g., the spectrum access grant 20). The SAS 30 can also provide and revoke spectrum access grants to the network entities. In this manner, the SAS 30 can dynamically provide and revoke spectrum access to and from network entities based on network conditions or other conditions.

The SAS 30 can implement tiered access to the network 24 by revoking access from non-incumbent network entities and granting access to incumbent entities. More specifically, in some instances, incumbent network entities may require communications with minimal interference from non-incumbent network entities (e.g., to enable public services, national defense functions, first responder services, etc.). Communications from non-incumbent entities located within a certain range of the incumbent entity can cause interference. As such, when the SAS 30 receives a spectrum access request from an incumbent entity, the SAS 30 can revoke any spectrum access grants provided to non-incumbent entities for antenna device(s) that are located within a certain range of the incumbent network entity, and/or are communicating in the direction of the incumbent entity.

To follow the depicted example, assume that the antenna device(s) 22 are located within a particular range of an incumbent network entity 32 (or antenna device(s) associated with the incumbent network entity 32). The incumbent network entity 32 can begin to utilize spectrum, or a region of spectrum, managed by the SAS 30. Environmental Sensing Capability (ESC) device(s) positioned in, or around, the geographic area in which the incumbent network entity 32 is located can detect the spectrum utilization by the incumbent network entity 32. As described herein, an ESC device refers to a device operable to detect nearby spectrum utilization by incumbent network entities within access-mediated networks. The ESC devices 34 can be acquired, placed within the geographic area, and/or maintained by governmental entities (e.g., the same entities that implement the SAS 30, etc.), neutral entities contracted by the governmental entity, the non-incumbent network entity 10, etc.

The ESC devices, upon detecting the utilization of spectrum by the incumbent network entity 34, can provide incumbent detection information 35 to the SAS 30. The incumbent detection information 35 can indicate the detected spectrum utilization by the incumbent network entity 32. In response, The SAS can also revoke the spectrum access grant 20 from the non-incumbent network entity 10. The SAS can provide grant revocation information 36 to the non-incumbent network entity 10. The grant revocation information 36 can indicate to the non-incumbent network entity 10 that the SAS 30 has revoked the spectrum access grant 20. In some implementations, the grant revocation information 36 can indicate a predicted spectrum utilization duration by the incumbent network entity 32. To follow the depicted example, the grant revocation information 36 indicates that the incumbent network entity 32 is predicted to utilize the spectrum for the next 300 seconds.

Additionally, or alternatively, in some implementations, the grant revocation information 36 can include location information. The location information can describe a location for the incumbent network entity 32, and/or a location for antenna device(s) utilized by the incumbent network entity 32. Additionally, or alternatively, in some implementations, the grant revocation information 36 can include interference information. The interference information can describe or otherwise indicate various characteristic(s) of the antenna device(s) utilized by the incumbent network entity 32, such as antenna height, location, azimuth, beam width, etc.

Upon receipt of the grant revocation information 36, the non-incumbent network entity 10 can determine that the spectrum access grant 20 has been revoked by the SAS 30. With the spectrum access grant 20 revoked by the SAS 30, the antenna device(s) 22 do not possess a configuration granted by the SAS 30, and thus cannot utilize the network 24. The spectrum access handler 16 can attempt to restore access to the network 24 by requesting another spectrum access grant from the SAS 30. However, the SAS 30 will likely reject a spectrum access request that may cause interference with the incumbent network entity 32.

As such, the spectrum access handler 16 can generate a second antenna configuration 28-2 for the antenna device(s) 22. The spectrum access handler 16 can store the antenna configuration 28-2 to the antenna device configuration store 26. The antenna configuration 28-2 can be a configuration predicted to cause less interference between the non-incumbent network entity and the incumbent network entity 32. More specifically, the spectrum access handler 16 can determine which parameter values of the antenna configuration 28-1 are likely to cause interference with the incumbent network entity 32, and can modify those values to reduce the likelihood of causing such interference.

In some implementations, the antenna configurations 28 can include a “power” (i.e., PWR) parameter and a direction (i.e., “D”) parameter. The direction parameter indicates a direction in which an antenna device is configured to transmit. More specifically, the direction parameter indicates a direction to which a beam formed by one of the antenna device(s) 22 points. When the power parameter is assigned a value of 1, a corresponding antenna device is active, and when the power parameter is assigned a value of 0, a corresponding antenna device is active. Additionally, or alternatively, in some implementations, the antenna configurations 28 can include a power parameter with a scalar value that controls a degree of power supplied to the antenna device or utilized by the antenna device.

Additionally, or alternatively, in some implementations, the antenna configurations 28 can control activation and deactivation of antenna device(s) 22 in some other manner. For example, in some implementations, the power parameter can be a scalar value that controls transmission power for the antenna device, and the antenna configurations 28 can include another “activation” parameter that controls whether an antenna device is activated or deactivated.

It should be noted that the values of the direction parameter are illustrated as cardinal directions only to more easily illustrate various implementations described herein. However, the direction parameter can describe a directionality of an antenna in any manner. For example, the direction parameter may indicate a two-dimensional or three-dimensional vector descriptive of a direction for a beam formed by the antenna. For another example, the direction parameter may indicate a particular sector, region, or other area demarcated by the non-incumbent network entity 10 and/or the SAS 30. For yet another example, the direction parameter may indicate a transmission angle for a beam formed by the antenna device, a portion of a circumference around the antenna device, etc.

To follow the depicted example, assume that the incumbent network entity 32 is due east of the antenna device(s) 22, and that the antenna device(s) 22 include four antenna devices that transmit north (AD01), south (AD02), west (AD03), and east (AD04), respectively. The antenna configuration 28-1 can include a value of 1 for each of the four antenna devices, and thus each of the four antenna devices is active when configured with the antenna configuration 28-1. The spectrum access handler 16 can generate the antenna configuration 28-2 with a value of 0 assigned to the power parameter for the antenna AD03 that points east towards the incumbent network entity 32. As the antenna configuration 28-2 deactivates the antenna device that transmits towards the incumbent network entity 32, and is thus most likely to cause interference, the SAS 30 is more likely to accept a spectrum access grant that includes the antenna configuration 28-3.

In some implementations, the spectrum access handler 16 can include a machine-learned antenna configuration model 38. The machine-learned antenna configuration model 38 can be a machine-learned model trained to process an input antenna configuration (or an input derived from an antenna configuration, and generate an output antenna configuration less likely to cause interference with the incumbent network entity. Alternatively, the machine-learned antenna configuration model 38 can be trained to generate an output antenna configuration more likely to be granted by the SAS 30 than the input antenna configuration. Additionally, or alternatively, in some implementations, the machine-learned antenna configuration model 38 can be trained to generate values for some, or all, of the parameters included in the antenna configurations 28.

The machine-learned antenna configuration model 38 can be any type or manner of machine-learned model. can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

The machine-learned antenna configuration model 38 can include a single or multiple instances of the same model configured to operate on data from input(s). In some implementations, the machine-learned antenna configuration model 38 can include an ensemble of different models that can cooperatively interact to process data from the input(s). For example, the machine-learned antenna configuration model 38 can employ a mixture-of-experts structure.

Inputs to, and outputs from, the machine-learned antenna configuration model 38 can include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In some implementations, the spectrum access handler 16 can include a model trainer 40. The model trainer 40 can perform a training process to train the machine-learned antenna configuration model 38. In particular, the model trainer 40 can generate an evaluation signal by evaluating an output of the machine-learned antenna configuration model 38 with an optimization function. For example, the model trainer 40 can include, or otherwise access, historic access request information 42. The historic access request information 42 can include training pairs. In some implementations, a training pair can include a prior spectrum access request submitted to the SAS 30, and a corresponding response received from the SAS 30 (e.g., a response that accepts the request, denies the request, etc.). Additionally, or alternatively, in some implementations, a training pair can include a set of inputs for the model and a corresponding ground-truth antenna configuration (e.g., an “ideal” configuration).

The model trainer 40 can update values of parameters of the machine-learned antenna configuration model 38 based on the evaluation signal. For example, values for parameters of the machine-learned antenna configuration model 38 can be learned, in some implementations, using various training or learning techniques, such as, for example, backwards propagation. For example, the evaluation signal can be backpropagated from the output (or another source of the evaluation signal) through the machine-learned antenna configuration model 38 to update one or more parameters of the model (e.g., based on a gradient of the evaluation signal with respect to the parameter value(s)). For example, system(s) containing the machine-learned antenna configuration model 38 can be trained in an end-to-end manner. Gradient descent techniques can be used to iteratively update the parameters over a number of training iterations.

In some implementations, performing backwards propagation of errors can include performing truncated backpropagation through time. The training process performed by the model trainer 40 can include implementing a number of generalization techniques (e.g., weight decays, dropouts, etc.) to improve the generalization capability of the models being trained.

In some implementations, the training process performed by the model trainer 40 can be implemented for training a machine-learned model from an initialized state to a fully trained state (e.g., when the model exhibits a desired performance profile, such as based on accuracy, precision, recall, etc.).

Additionally, or alternatively, in some implementations, the training process performed by the model trainer 40 can be implemented for particular stages of a training procedure. For instance, in some implementations, the training process can be implemented for pre-training a machine-learned model. Pre-training can include, for instance, large-scale training over potentially noisy data to achieve a broad base of performance levels across a variety of tasks/data types.

In some implementations, the training process performed by the model trainer 40 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

The machine-learned antenna configuration model 38 can be trained to process a variety of inputs to generate the model output. The model inputs can include prior antenna configuration(s), some or all of the grant revocation information 36, historic access request information 42, etc.

In some implementations, the spectrum access handler 16 can include incumbent entity information 44, and can utilize the incumbent entity information 44 as an input to the machine-learned antenna configuration model 38. The incumbent entity information 44 can include information associated with the incumbent network entity 32 (e.g., prior transmission patterns or characteristics, prior locations utilized by the incumbent network entity 32, prior grant durations for grants provided to the incumbent network entity 32, etc.).

Additionally, or alternatively, in some implementations, the spectrum access handler 16 can include antenna device information 46. The antenna device information 46 can describe certain characteristics of the antenna device(s) 22, and can be utilized as an input to the machine-learned antenna configuration model 38. Such characteristics can include an antenna device model, antenna device vendor identity, CBSD model, device versioning information (e.g., hardware version, software version, firmware version, etc.), device downtilt, antenna gain, antenna beam width, antenna height, antenna location, antenna deployment environment (e.g., indoor or outdoor deployment), EIRP capability, horizontal accuracy, vertical accuracy, device identifiers for various systems and networks, etc.

Once the antenna configuration 28-2 is generated, the non-incumbent network entity 10 can transmit a non-incumbent spectrum access request 48 to the SAS 30. The non-incumbent spectrum access request 48 can request access to the antenna configuration 28-2 for the antenna device(s) 22. In some implementations, the non-incumbent spectrum access request 48 can include the antenna configuration 28. Alternatively, in some implementations, the non-incumbent spectrum access request 48 can describe some, or all, of the antenna configuration 28-2 (e.g., value(s) for parameter(s) of the antenna configuration 28-2, etc.). The SAS 30 can receive and evaluate the non-incumbent spectrum access request 48. Specifically, the SAS 30 can determine whether the antenna configuration 28-2 included in (or described by) the non-incumbent spectrum access request 48 is likely to cause interference with the incumbent network entity 32.

Based on the evaluation, the SAS 30 can provide decision information 50 to the spectrum access handler 16. If the decision information 50 indicates that the non-incumbent spectrum access request has been granted by the SAS 30, the decision information 50 can be, or otherwise include, a second spectrum access grant 52. Alternatively, the SAS 30 can separately provide the second spectrum access grant 52. Granting of the second spectrum access grant 52 can enable the spectrum access handler 16 to configure (i.e., apply) the antenna configuration 28-2 to the antenna device(s) 22. Once configured with the antenna configuration 28-2, the antenna device(s) 22 can communicate via the network 24.

Alternatively, if the decision information 50 indicates that the non-incumbent spectrum access request has been denied by the SAS 30, the spectrum access handler 16 can generate a third antenna configuration 28-N for the antenna device(s) 22. In some implementations, the antenna configuration 28-N can be a more “conservative” configuration than the antenna configuration 28-2 to further increase the likelihood that the antenna configuration 28-N is granted by the SAS 30. In other words, the antenna device(s) 22, when configured with the antenna configuration 28-N, can provide coverage of a geographic area smaller (or at least different) than the geographic area provided when the antenna device(s) 22 are configured with the antenna configuration 28-2.

To follow the depicted example, assume that the incumbent network entity 32 is located east and slightly to the south of the antenna device(s) 22. As described previously, the antenna configuration 28-2 can deactivate the antenna device AD04 that transmits east towards the incumbent network entity 32. However, as the incumbent network entity 32 is also located slightly to the south of the antenna device(s) 22, the SAS 30 may determine that the antenna device AD02, which transmits south, is likely to cause interference with the incumbent network entity 32. The antenna configuration 28-N can deactivate both antenna devices AD04 and AD02 to further mitigate the risk of interference caused by the antenna device(s) 22. The non-incumbent network entity 10 can then transmit a second non-incumbent spectrum access request to the SAS 30 that includes the antenna configuration 28-N. In this manner, the spectrum access handler 16 can iteratively generate more conservative, or restrictive, antenna configurations 28 until a spectrum access grant is granted by the SAS 30.

FIG. 1B is a block diagram of an environment suitable for implementing bulk antenna device reconfiguration following bulk incumbent-based suspension according to some implementations of the present disclosure. FIG. 1B will be discussed in conjunction with FIG. 1A. Specifically, FIG. 1B illustrates a plurality of radio devices 54-1-54-3 (generally, radio devices 54). The radio devices 54 each include a subset of the antenna device(s) 22. To follow the depicted example, the radio device 54-1 may include the antenna devices 22 identified as AD01, AD02, AD03, and AD04, while the radio device 54-2 may include the antenna devices 22 identified by other antenna device identifiers.

The radio devices 54 can utilize the network 24 with the spectrum access grant 20. In some implementations, the spectrum access grant 20 can include multiple grants for the radio devices 54 (e.g., one grant per radio device). Alternatively, the spectrum access grant 20 can include a single grant for the radio devices 54. Alternatively, the spectrum access grant 20 can a different grant for each antenna device of each of the radio devices 54.

Each of the radio devices 54 can be located a particular distance from the incumbent network entity 32, and/or the utilization detected by the ESC device(s) 34. For example, the radio devices 54 can be located within, or within a particular range of, a Dynamic Protection Area (DPA) in which the incumbent network entity 32 is located. As described herein, a DPA refers to a geographical region where spectrum utilization may dynamically change based on the presence of incumbent users or other factors that necessitate protection or coordination.

Due to the proximity of the radio devices 54 to the incumbent network entity 32, the SAS 30 can revoke the spectrum access grant 20 for the radio devices 54 in response to the incumbent detection information 35. The non-incumbent network entity 10 can begin the re-registration process for the radio devices 54 as described with regards to FIG. 1A. However, due to multiple radio devices being suspended, the non-incumbent network entity 10 can, in some implementations, perform a bulk-registration process.

The bulk re-registration process can be utilized to perform concurrent, mass re-registration of large numbers of radio devices. More specifically, the bulk re-registration process can submit proposed configurations for all suspended radio devices at once to the SAS 30, and the SAS 30 decision information 50 provided by the SAS 30 in response can indicate acceptance or rejection for all suspended radio devices. In this manner, the non-incumbent network entity 10 can re-register a large number of suspended radio devices without the need to perform the re-registration process on a per-device basis, thus substantially increasing efficiency and re-registration speed. In turn, by increasing the speed in which radio devices are re-registered, the non-incumbent network entity 10 can substantially reduce, or eliminate, network performance degradation caused by grant suspension.

To perform the bulk re-registration process, the non-incumbent network entity 10 can provide a bulk registration object request 56 for the radio devices 54 that have been suspended. In response, the SAS 30 can provide current registration objects 58. The current registration objects 58 can include the registration objects that were previously accepted and then revoked by the SAS in response to the incumbent detection information 35.

The current registration objects 58 can include at least some of the antenna configuration(s) 28. More generally, as described herein, a registration object can refer to a structured data object, or data structure, that includes some or all configuration parameter(s) included in the antenna configurations 28. For example, the registration object may be a structured data object with a structure or format that is specified by the SAS (e.g., for accurate parsing of registration requests, etc.).

As depicted, the antenna device configuration store can, in some implementations, also store radio device configurations 29 for the radio devices 54. In some implementations, the radio device configurations 29 can include, or indicate, multiple antenna configurations for multiple antenna devices. For example, if the radio device 54-1 includes the antenna devices 22 with identifiers AD01, AD02, AD03, and AD04, the radio device configuration for the radio device 54-1 can include the antenna configurations 28-1-28-N for those antenna devices.

Based on the current registration objects 58, the non-incumbent network entity 10 can generate and provide the non-incumbent spectrum access request 48 to the SAS 30. The non-incumbent spectrum access request 48 can include a bulk registration object 60. As described previously, the bulk registration object 60 can include registration objects for each suspended radio device (e.g., the radio devices 54). To follow the depicted example, the bulk registration object 60 can respectively include three registration objects for the three suspended radio devices 54-1, 54-2, and 54-3. Each object of the bulk registration object 60 can indicate modifications to antenna pattern, antenna gain, transmission power, beam width, etc. for some (or all) of the antenna device(s) 22 included in the radio device(s) 54.

In response, the spectrum access system can provide the decision information 50 to the non-incumbent network entity 10. The decision information 50 can be, or describe, a bulk registration decision that accepts, or rejects, each of the bulk registration objects 60. For example, the decision information 50 may accept the bulk registration object 60 for the radio device 54-1 while rejecting the bulk registration objects 60 for the radio device 54-2 and 54-3. For the radio devices 54 with registration objects that are accepted, the radio devices 54 can undergo registration with the registration object 60 before a “heart beat” indication enables signal propagation via the radio device. Conversely, for the radio devices 54 with rejected bulk registration objects, the spectrum access handler can generate a new registration object based on more conservative parameters (e.g., more limited coverage) and can submit the new registration object to the SAS. The spectrum access handler 16 can repeat this process until a grant is received. When incumbent activity stops, the spectrum access handler 16 is informed, and re-registration of the radio devices 54 with their original registration objects (e.g., the current registration objects 58 received from the SAS 30, etc.).

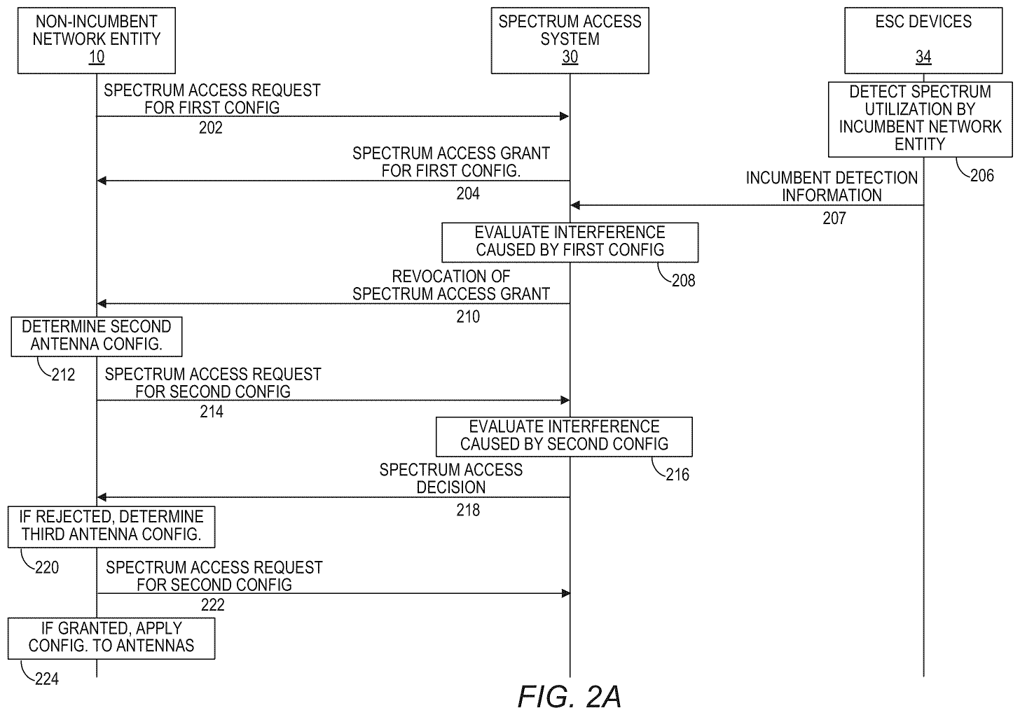

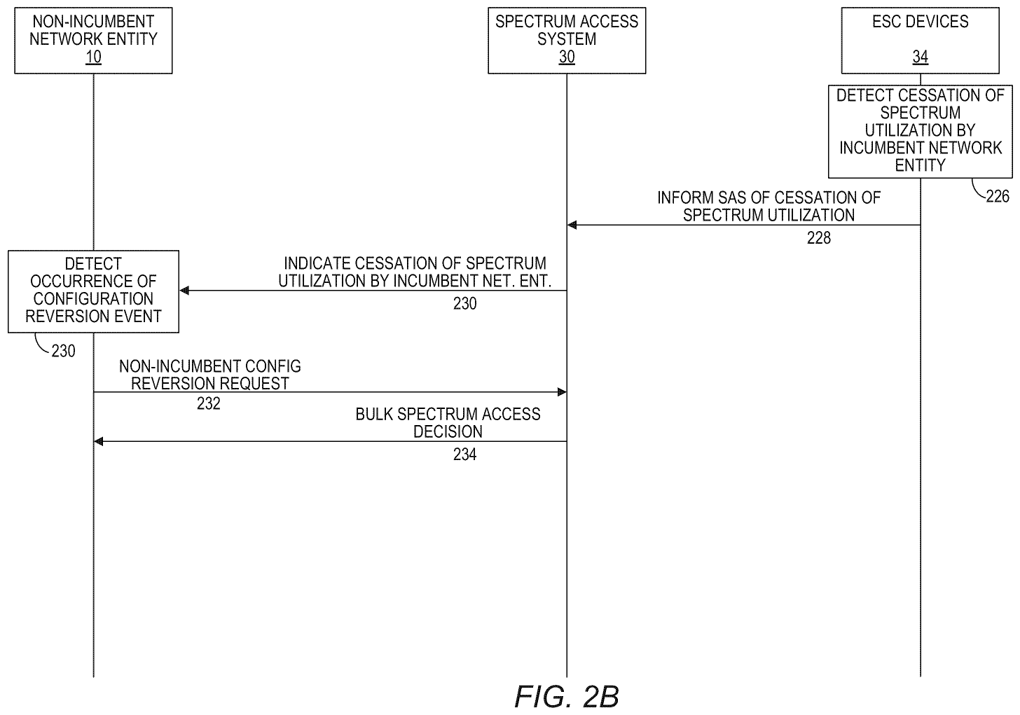

FIG. 2A is a communication flow diagram for communication between network entities and a SAS for implementing dynamic antenna device reconfiguration for spectrum access requests according to some implementations of the present disclosure. FIG. 2A will be discussed in conjunction with FIGS. 1A and 1B. Specifically, at 202, the non-incumbent network entity 10 can provide a spectrum access request for the antenna configuration 28-1 to the SAS 30. In response, at 204 the SAS 30 can provide the spectrum access grant 20 to the non-incumbent network entity 10. The spectrum access grant 20 can enable the non-incumbent network entity 10 to configure the antenna device(s) 22 for communication via the network 24.

At 206, the ESC devices 34 can detect spectrum utilization by the incumbent network entity 32. In response, at 207, the ESC devices 34 can provide incumbent detection information to the SAS 30. In some implementations, the incumbent detection information can describe the incumbent network entity itself. For example, the incumbent detection information can indicate a location of the incumbent network entity, a type of network entity associated with the incumbent network entity (e.g., a ship, a plane, a radio tower, etc.), historic utilization information for the incumbent network entity, etc. Additionally, or alternatively, in some implementations, the incumbent detection information can describe the spectrum utilization by the incumbent network entity (e.g., a beam direction, a beam width, a particular region of frequency, etc.).

At 210, based on the evaluation, the SAS 30 can send the grant revocation information 36 to the non-incumbent network entity 10 to indicate that the spectrum access grant 20 has been revoked. At 212, the non-incumbent network entity can determine the antenna configuration 28-2 as described with regards to FIG. 1.

At 214, the non-incumbent network entity 10 can provide the non-incumbent spectrum access request 48 to the SAS 30. At 216, the SAS 30 can evaluate interference (e.g., predicted interference, actual interference, etc.) caused by the antenna configuration 28-2. At 218, based on the evaluation, the SAS 30 can send the decision information 50 to the non-incumbent network entity 10.

If the decision information 50 indicates that the SAS 30 has rejected the non-incumbent spectrum access request 48, the non-incumbent network entity 10 can generate the antenna configuration 28-N at 220. At 222, the non-incumbent network entity 10 can transmit a second spectrum access request for the antenna configuration 28-N to the SAS 30. Alternatively, if the decision information 50 indicates that the SAS 30 has accepted the non-incumbent spectrum access request 48, the non-incumbent network entity 10 can configure the antenna device(s) 22 with the antenna configuration 28-2 at 224.

It should be noted that some of the actions described herein can be performed by network functions, devices, and/or entities implemented by or associated with the non-incumbent network entity 10. For example, assume that the non-incumbent network entity 10 implements a base station and Operations Support System (OSS)/Domain Proxy (DP) network functions. At 210, the SAS may first send the revocation to the OSS/DP of the non-incumbent network entity 10, and the OSS/DP can inform the base station of revocation. The OSS/DP can provide all radios with suspended grants.

Further, in some instances, actions described as being performed by the non-incumbent network entity 10 may be performed by a particular network function implemented by the non-incumbent network entity 10, such as a SAS Reconciliation Function (SRF). For example, the spectrum access handler 16 described with regards to FIGS. 1A and 1B may be or otherwise implement a SRF or analogous network function. To provide a more detailed example, the following section details the registration process as performed by the network function(s) and/or entity(s) described above.

The SRF may receive the grant suspension from the SAS and provide it to the OSS/DP. The SRF may determine radio devices capable of limited coverage. The SRF can provide a bulk request for all cells with suspended grants to the SAS. The bulk request can include current registration objects for all suspended radio devices. The SAS can provide the current registration objects to the SRF, and the SRF can populate new objects for the suspended radio devices. The SRF can instruct the SAS to remove old registrations for suspended radio devices and, once complete, can receive confirmation of old registration removal from the SAS. The SRF can forward registration removal confirmation to the OSS/DP and can provide a bulk registration request to the SRF that includes the newly populated registration objects.

The SRF can receive bulk acceptance and/or rejection of the new registration objects. For accepted requests, the SAS can provide spectrum access grant(s) for the accepted radio device(s) to the OSS/DP (e.g., either directly or indirectly via the SRF). The OSS/DP can prepare the radio devices internally for the new spectrum access grants. The OSS/DP can confirm changes to antenna patterns with the base station.

Conversely, for rejected requests, the SRF can re-populate the newly populated objects with more conservative parameters. For example, if the SRF populated the registration object for one radio device with a first transmission power parameter, and the registration object was rejected, the SRF may re-populate the registration object with a more conservative transmission power parameter to replace the first transmission power parameter.

The SRF continue to communicate with the OSS/DP and the SAS by providing increasingly conservative registration objects until a registration object has been accepted for each suspended radio device. If the incumbent network entity ceases utilization of the spectrum, the cessation can be detected by the ESC device(s) 34, which in turn can inform the SAS. The SAS can forward this indication to the SRF and the OSS/DP. The OSS/DP can provide subscription information to the SRF. The SRF can utilize “old” registration objects (e.g., the registration objects originally submitted to register the radio devices with the SAS). In such fashion, the non-incumbent network entity can implement multiple network functions to more efficiently restore spectrum access to suspended radio devices.

FIG. 2B is a communication flow diagram for performing configuration reversion for radio devices of a non-incumbent network entity following cessation of spectrum utilization by an incumbent network entity according to some implementations of the present disclosure. FIG. 2B describes operations that, in some implementations, can be performed subsequent to the operations described in FIG. 2A, and will be discussed in conjunction with FIGS. 1A, 1B, and 2A. Specifically, at 226, the ESC devices 34 can detect cessation of spectrum utilization by the incumbent network entity. In other words, the ESC devices 34 can detect that the incumbent network entity 32 has stopped using the spectrum. In response, at 228, the ESC devices 34 can inform the SAS 30 of cessation of utilization of the spectrum.

At 230, the non-incumbent network entity 10 can detect occurrence of a configuration reversion event. In some implementations, the configuration reversion event can refer to cessation of spectrum utilization by the incumbent network entity 32. Alternatively, in some implementations, the configuration reversion event can refer to some other occurrence (e.g., a certain amount of time passing since antenna configurations were revoked by the SAS, etc.).

At 232, the non-incumbent network entity can provide a non-incumbent configuration reversion request to the SAS 30. The non-incumbent configuration reversion request can be structured in the same manner as the non-incumbent spectrum access request 48 described with regards to FIGS. 1A/1B. However, the non-incumbent configuration reversion request can reversion of changes made to the configurations of the radio devices 54 in response to revocation of the spectrum access grants due to incumbent network activity. In other words, the non-incumbent configuration reversion request can request that the original configurations of the radio devices 54 prior to detection of incumbent network activity be restored.

At 234, the SAS 30 can provide a bulk spectrum access decision to the non-incumbent network entity 10. The bulk spectrum access decision can include a spectrum access decision for each radio device with a corresponding registration object included in the non-incumbent configuration reversion request.

In some implementations, the non-incumbent configuration reversion request can include the bulk registration objects 56 received from the SAS in response to the request for registration objects 58. The bulk registration objects 56 can be those used to register and configure the radio devices 54.

For example, assume that the radio device 54-1 was originally configured based on a registration object that described a first transmission power for the antennas of the radio device 54-1. Further assume that the bulk registration object 60 provided to the SAS 30 was rejected, and it described a second transmission power for the antennas of the radio device 54-1 less than the first transmission power. To restore the radio device 54-1 to its original configuration, the non-incumbent configuration reversion request 54 can include the “old” or original registration object that specified the first transmission power. In this manner, the non-incumbent network entity 10 can quickly and efficiently restore original configurations for radio devices, thus further reducing network disruption caused by incumbent network activity.

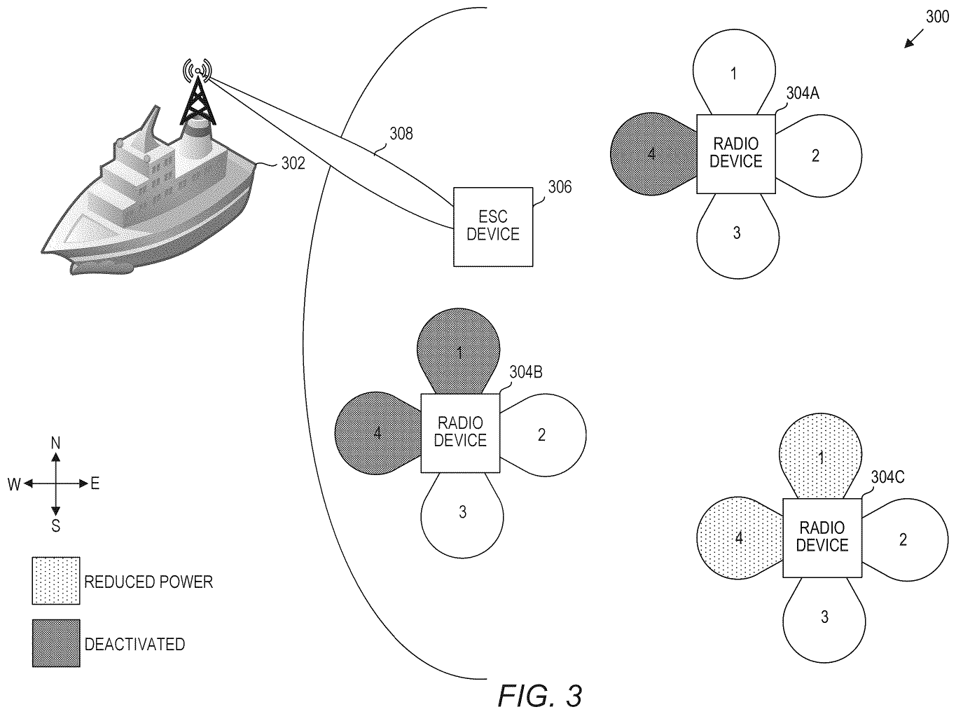

FIG. 3 depicts a communication environment 300 in which configurations for antenna devices are dynamically reconfigured to reduce predicted interference according to some implementations of the present disclosure. FIG. 3 will be discussed in conjunction with FIGS. 1A and 1B. Specifically, the communication environment 300 includes a communicating entity 302, radio devices 304A, 304B, and 304C (generally, radio devices 304), and ESC device 306. The communicating entity 302 can be an entity associated with the incumbent network entity 32 that includes antenna devices for communicating via the network 24. The radio devices 304 can be associated with the non-incumbent network entity 10, and can include four antenna devices that broadcast in north, south, east, and west directions respectively.

As depicted, the communicating entity 302 associated with the incumbent network entity 32 can begin transmitting a beam 308. The ESC device 306 can detect the beam transmitted by the communicating entity 302 and can inform the SAS 30 that an incumbent network entity is utilizing the spectrum. In response, the SAS can revoke the spectrum access grant previously provided for the antenna devices of the radio devices 304. Further, the SAS 30 grants the non-incumbent spectrum access request 48 for the antenna configuration 28-2, and the non-incumbent network entity 10 applies the antenna configuration 28-2 to the antenna device(s) of the radio devices 304.

To follow the depicted example, the antenna configuration 28-2 has modified the behavior, or parameter values, of certain antenna devices of each of the radio devices 304 to reduce the likelihood of interference being caused between the radio devices 304 and the communicating entity 302. For example, as antenna device 4 of the radio device 304A radiates directly towards the communicating entity 302, the antenna configuration 28-2 has deactivated antenna device 4 while keeping antenna devices 1-3 activated. For another example, as the antenna devices 1 and 4 of the radio device 304B radiate towards the communicating entity 302, the antenna configuration 28-2 has deactivated antenna devices 1 and 4 while keeping antenna devices 2 and 3 activated.

For another example, the antenna devices 1 and 4 of the radio device 304C also radiate towards the direction of the communicating entity 302. However, the distance between the communicating entity 302 and the radio device 304C is greater than the distance between the communicating entity 302 and the radio devices 304A/304B. As such, in some implementations, the antenna configuration 28-2 can reduce power to the antenna devices 1 and 4 rather than deactivating them entirely. Due to the increased distance, the reduction in power to antenna devices 1 and 4 of the radio device 304C can be sufficient to avoid interference without complete deactivation of the antenna devices.

Alternatively, in some implementations, the antenna configuration 28-2 can modify various characteristics of the antenna devices of the radio devices 304 while remaining active. For example, rather than deactivate the antenna device 4 of the radio device 304A, the antenna configuration 28-2 may instead modify a beam width, beam height, azimuth, transmission power, antenna gain, downtilt, etc. (not illustrated).

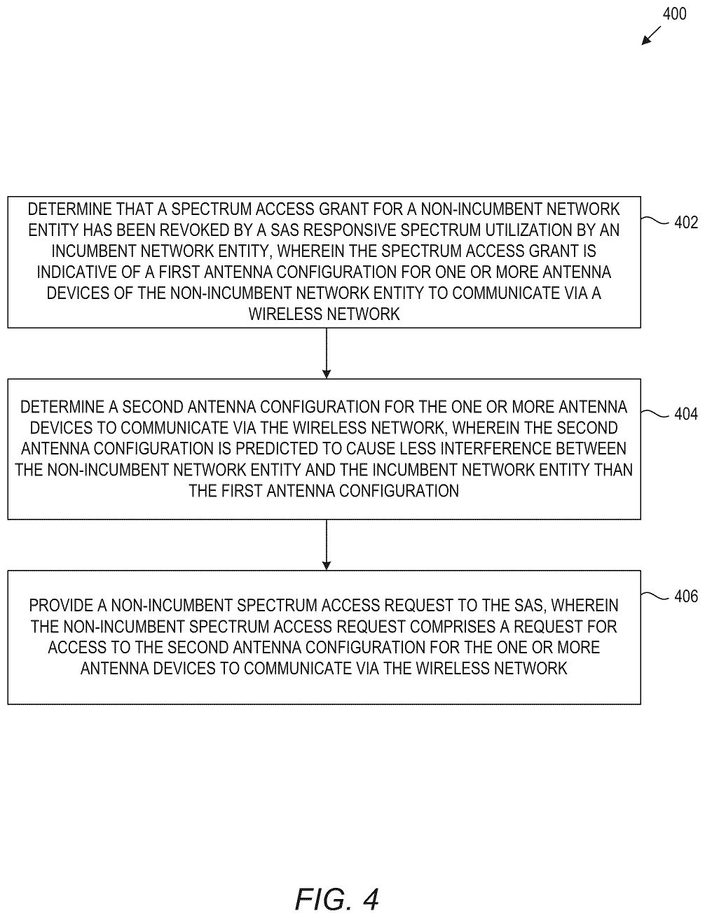

FIG. 4 depicts a flow chart diagram of an example method to perform dynamic antenna device reconfiguration for spectrum access requests following incumbent-based suspension according to some implementations of the present disclosure. Although FIG. 4 depicts operations performed in a particular order for purposes of illustration and discussion, the methods of the present disclosure are not limited to the particularly illustrated order or arrangement. The various operations of the method 400 can be omitted, rearranged, combined, and/or adapted in various ways without deviating from the scope of the present disclosure.

At operation 402, a computing system can determine that a spectrum access grant for a non-incumbent network entity has been revoked by a SAS responsive to spectrum utilization by an incumbent network entity. The spectrum access grant can be indicative of a first antenna configuration for one or more antenna devices of the non-incumbent network entity to communicate via a wireless network.

In some implementations, the computing system can determine that the spectrum access grant for the non-incumbent network entity has been revoked by the SAS responsive to detection of spectrum utilization by an ESC device, the incumbent network entity. For example, the incumbent network entity may begin to utilize a particular region of frequency spectrum to which access is mediated by the SAS. An ESC device can detect such utilization and can report to the SAS.

The spectrum access grant can grant access to the first antenna configuration for a plurality of antenna devices associated with non-incumbent network entity to communicate via the wireless network. Determining the second antenna configuration can include determining a second antenna configuration for the plurality of antenna devices to communicate via the wireless network. The first antenna configuration can form a plurality of beams including a first beam that points towards a location of the incumbent entity, and the second antenna configuration can form a second plurality of beams each pointing towards locations other than the location of the incumbent entity.

At operation 404, the computing system can determine a second antenna configuration for the one or more antenna devices to communicate via the wireless network, wherein the second antenna configuration is predicted to cause less interference between the non-incumbent network entity and the incumbent network entity than the first antenna configuration.

In some implementations, the computing system can determine the second antenna configuration by processing a set of inputs comprising the first antenna configuration with a machine-learned antenna configuration model to obtain the second antenna configuration. In some implementations, the set of inputs further includes information indicative of a location of the incumbent network entity.

At operation 406, the computing system can provide a non-incumbent spectrum access request to the SAS. The non-incumbent spectrum access request can include a request for access to the second antenna configuration for the one or more antenna devices to communicate via the wireless network.

In some implementations, the computing system can determine that a second spectrum access grant has been provided to the non-incumbent network entity. The second spectrum access grant can grant access to the second antenna configuration for the one or more antenna devices to communicate via the wireless network. In some implementations, the set of inputs further includes historical information indicative of a prior non-incumbent spectrum access request provided to the SAS and a corresponding response received from the SAS.

In some implementations, the computing system can detect occurrence of a configuration reversion event. For example, the computing system can determine that a spectrum access grant for the incumbent network entity has been revoked by the SAS. For another example, the computing system can determine that a period of time has passed since either (a) the SAS revoked the spectrum access grant for the non-incumbent network entity, or (b) the incumbent network entity last communicated via the wireless network.

Responsive to detecting the occurrence of the configuration reversion event, the computing system can provide, to the SAS, a non-incumbent configuration reversion request. The non-incumbent configuration reversion request includes a request to restore access to the first antenna configuration for the one or more antenna devices to communicate via the wireless network.

In some implementations, the computing system can, responsive to providing the non-incumbent spectrum access request, receive, from the SAS, information indicating denial of the non-incumbent spectrum access request. In some implementations, the computing system can determine a third antenna configuration for the one or more antenna devices to communicate via the wireless network. The third antenna configuration is predicted to cause less interference between the non-incumbent network entity and the incumbent network entity than the second antenna configuration. In some implementations, the computing system can provide a second non-incumbent spectrum access request to the SAS. The second non-incumbent spectrum access request can include a request for access to the third antenna configuration for the one or more antenna devices.

In some implementations, the computing system can obtain information indicating that the SAS has denied the non-incumbent spectrum access request. The computing system can train the machine-learned antenna configuration model based on the non-incumbent spectrum access request and the information indicating that the SAS has denied the non-incumbent spectrum access request.

In some implementations, the first antenna configuration provides coverage of a first portion of a geographic area in which the one or more antenna devices are located, and the second antenna configuration provides coverage of a second portion of the geographic area that is less than then first portion of the geographic area. In some implementations, the first antenna configuration causes the one or more antenna devices to form a beam that interferes with communications from the incumbent entity, and second antenna configuration modifies a value of a parameter associated with the beam.

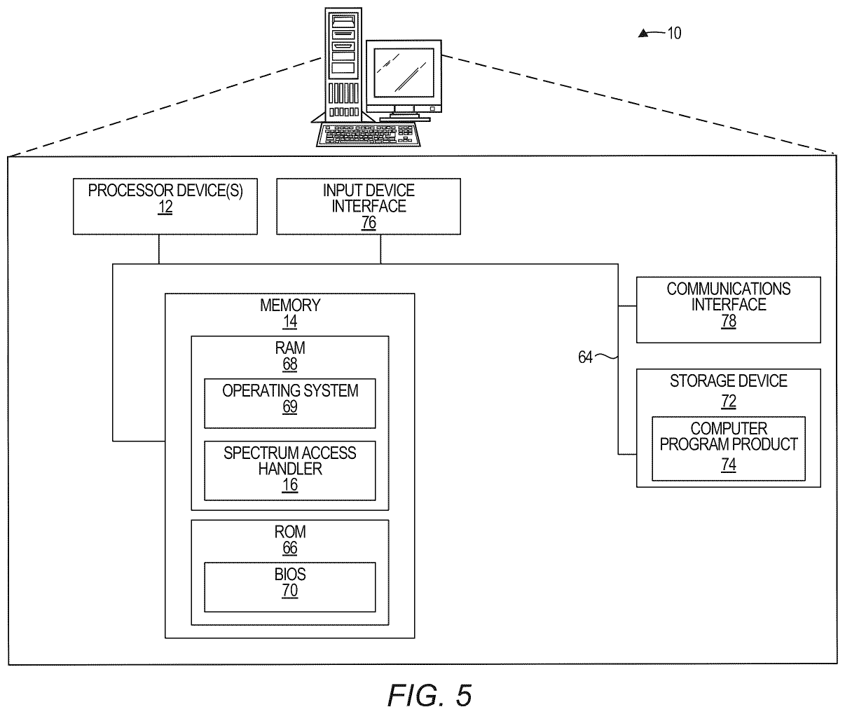

FIG. 5 is a block diagram of the non-incumbent network entity 10 suitable for implementing examples according to one example. The non-incumbent network entity 10 may comprise any computing or electronic device capable of including firmware, hardware, and/or executing software instructions to implement the functionality described herein, such as a computer server, a desktop computing device, a laptop computing device, a smartphone, a computing tablet, or the like. The non-incumbent network entity 10 includes the processor device(s) 12, the memory 14, and a system bus 64. The system bus 64 provides an interface for system components including, but not limited to, the memory 14 and the processor device(s) 12. The processor device(s) 12 can be any commercially available or proprietary processor.

The system bus 64 may be any of several types of bus structures that may further interconnect to a memory bus (with or without a memory controller), a peripheral bus, and/or a local bus using any of a variety of commercially available bus architectures. The memory 14 may include non-volatile memory 66 (e.g., read-only memory (ROM), erasable programmable read-only memory (EPROM), electrically erasable programmable read-only memory (EEPROM), etc.), and volatile memory 68 (e.g., random-access memory (RAM)). A basic input/output system (BIOS) 70 may be stored in the non-volatile memory 66 and can include the basic routines that help to transfer information between elements within the non-incumbent network entity 10. The volatile memory 68 may also include a high-speed RAM, such as static RAM, for caching data.

The non-incumbent network entity 10 may further include or be coupled to a non-transitory computer-readable storage medium such as the storage device 72, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 72 and other drives associated with computer-readable media and computer-usable media may provide non-volatile storage of data, data structures, computer-executable instructions, and the like.

A number of modules can be stored in the storage device 72 and in the volatile memory 68, including an operating system 69 and one or more program modules, such as the spectrum access handler 16, which may implement the functionality described herein in whole or in part. All or a portion of the examples may be implemented as a computer program product 74 stored on a transitory or non-transitory computer-usable or computer-readable storage medium, such as the storage device 72, which includes complex programming instructions, such as complex computer-readable program code, to cause the processor device(s) 12 to carry out the steps described herein. Thus, the computer-readable program code can comprise software instructions for implementing the functionality of the examples described herein when executed on the processor device(s) 12. The processor device(s) 12, in conjunction with the spectrum access handler 16 in the volatile memory 68, may serve as a controller, or control system, for the non-incumbent network entity 10 that is to implement the functionality described herein.

Because the spectrum access handler 16 is a component of the non-incumbent network entity 10, functionality implemented by the spectrum access handler 16 may be attributed to the non-incumbent network entity 10 generally. Moreover, in examples where the spectrum access handler 16 comprises software instructions that program the processor device(s) 12 to carry out functionality discussed herein, functionality implemented by the spectrum access handler 16 may be attributed herein to the processor device(s) 12.

An operator, such as a user, may also be able to enter one or more configuration commands through a keyboard (not illustrated), a pointing device such as a mouse (not illustrated), or a touch-sensitive surface such as a display device. Such input devices may be connected to the processor device(s) 12 through an input device interface 76 that is coupled to the system bus 64 but can be connected by other interfaces such as a parallel port, an Institute of Electrical and Electronic Engineers (IEEE) 1394 serial port, a Universal Serial Bus (USB) port, an IR interface, and the like. The non-incumbent network entity 10 may also include the communications interface 78 suitable for communicating with the network 24 as appropriate or desired. The non-incumbent network entity 10 may also include a video port configured to interface with a display device, to provide information to the user.

Individuals will recognize improvements and modifications to the preferred examples of the disclosure. All such improvements and modifications are considered within the scope of the concepts disclosed herein and the claims that follow.

What is claimed is:

1. A method, comprising:
determining, by a computing system comprising one or more computing devices, that a spectrum access grant for a non-incumbent network entity has been revoked by a Spectrum Access System (SAS) responsive to spectrum utilization by an incumbent network entity, wherein the spectrum access grant is indicative of a first antenna configuration for one or more antenna devices of the non-incumbent network entity to communicate via a wireless network;
determining, by the computing system, a second antenna configuration for the one or more antenna devices to communicate via the wireless network, wherein the second antenna configuration is predicted to cause less interference between the non-incumbent network entity and the incumbent network entity than the first antenna configuration; and
providing, by the computing system, a non-incumbent spectrum access request to the SAS, wherein the non-incumbent spectrum access request comprises a request for access to the second antenna configuration for the one or more antenna devices to communicate via the wireless network.

2. The method of claim 1, wherein the method further comprises:
determining, by the computing system, that a second spectrum access grant has been provided to the non-incumbent network entity, wherein the second spectrum access grant grants access to the second antenna configuration for the one or more antenna devices to communicate via the wireless network.

3. The method of claim 2, wherein the method further comprises:
detecting, by the computing system, occurrence of a configuration reversion event; and
responsive to detecting the occurrence of the configuration reversion event, providing, by the computing system to the SAS, a non-incumbent configuration reversion request, wherein the non-incumbent configuration reversion request comprises a request to restore access to the first antenna configuration for the one or more antenna devices to communicate via the wireless network.

4. The method of claim 3, wherein detecting occurrence of the configuration reversion event comprises:
determining, by the computing system, that the spectrum utilization by the incumbent network entity has ceased.

5. The method of claim 3, wherein detecting occurrence of the configuration reversion event comprises:
determining, by the computing system, that a period of time has passed since either:
(a) the SAS revoked the spectrum access grant for the non-incumbent network entity; or
(b) the incumbent network entity last communicated via the wireless network.

6. The method of claim 1, wherein the method further comprises:
responsive to providing the non-incumbent spectrum access request, receiving, by the computing system from the SAS, information indicating denial of the non-incumbent spectrum access request.

7. The method of claim 6, wherein the method further comprises:
determining, by the computing system, a third antenna configuration for the one or more antenna devices to communicate via the wireless network, wherein the third antenna configuration is predicted to cause less interference between the non-incumbent network entity and the incumbent network entity than the second antenna configuration; and
providing, by the computing system, a second non-incumbent spectrum access request to the SAS, wherein the second non-incumbent spectrum access request comprises a request for access to the third antenna configuration for the one or more antenna devices.

8. The method of claim 1, wherein determining that the spectrum access grant for the non-incumbent network entity has been revoked comprises:
determining, by the computing system, that the spectrum access grant for the non-incumbent network entity has been revoked by the SAS responsive to the spectrum utilization BY the incumbent network entity, wherein the spectrum access grant grants access to the first antenna configuration for a plurality of antenna devices associated with non-incumbent network entity to communicate via the wireless network; and
wherein determining the second antenna configuration comprises:
determining, by the computing system, a second antenna configuration for the plurality of antenna devices to communicate via the wireless network, wherein:
the first antenna configuration forms a plurality of beams comprising a first beam that points towards a location of the incumbent network entity; and
the second antenna configuration forms a second plurality of beams each pointing towards locations other than the location of the network incumbent entity.

9. The method of claim 1, wherein determining the second antenna configuration different than the first antenna configuration comprises:
processing, by the computing system, a set of inputs comprising the first antenna configuration with a machine-learned antenna configuration model to obtain the second antenna configuration.

10. The method of claim 9, wherein the set of inputs further comprises information indicative of a location of the incumbent network entity.

11. The method of claim 10, wherein the set of inputs further comprises historical information indicative of a prior non-incumbent spectrum access request provided to the SAS and a corresponding response received from the SAS.

12. The method of claim 11, wherein the method further comprises:
obtaining, by the computing system, information indicating that the SAS has denied the non-incumbent spectrum access request; and
training, by the computing system, the machine-learned antenna configuration model based on the non-incumbent spectrum access request and the information indicating that the SAS has denied the non-incumbent spectrum access request.

13. The method of claim 1, wherein the first antenna configuration provides coverage of a first portion of a geographic area in which the one or more antenna devices are located, and wherein the second antenna configuration provides coverage of a second portion of the geographic area that is less than then first portion of the geographic area.

14. The method of claim 13, wherein the first antenna configuration causes the one or more antenna devices to form a beam that interferes with communications from the incumbent network entity, and wherein second antenna configuration modifies a value of a parameter associated with the beam.

15. The method of claim 1, wherein the spectrum access grant for the non-incumbent network entity is revoked by the Spectrum Access System (SAS) responsive to incumbent detection information received from an Environmental Sensing Capability (ESC) device, wherein the ESC device detects spectrum utilization by incumbent network entities, and wherein the incumbent detection information is descriptive of the incumbent network entity and/or the spectrum utilization by the incumbent network entity.

16. A computing system, comprising:
a memory; and
one or more processor devices coupled to the memory configured to:
determine that a spectrum access grant for a non-incumbent network entity has been revoked by a Spectrum Access System (SAS) responsive to spectrum utilization by an incumbent network entity, wherein the spectrum access grant is indicative of a first antenna configuration for a plurality of antenna devices of the non-incumbent network entity to communicate via a wireless network;
process the first antenna configuration with a machine-learned antenna configuration model to obtain a second antenna configuration for the plurality of antenna devices to communicate via the wireless network, wherein the second antenna configuration is more likely to be granted by the SAS than the first antenna configuration;
provide a non-incumbent spectrum access request to the SAS, wherein the non-incumbent spectrum access request comprises a request for access to the second antenna configuration for the plurality of antenna devices; and
responsive to receiving information indicating that the SAS has granted the non-incumbent spectrum access request, apply the second antenna configuration to the plurality of antenna devices.

17. The computing system of claim 16, wherein the one or more processor devices coupled to the memory are further configured to:
determine that a second spectrum access grant has been provided to the non-incumbent network entity, wherein the second spectrum access grant grants access to the second antenna configuration for the plurality of antenna devices to communicate via the wireless network.

18. The computing system of claim 16, wherein the one or more processor devices coupled to the memory are further configured to:
detect occurrence of a configuration reversion event; and
responsive to detecting the occurrence of the configuration reversion event, provide, to the SAS, a non-incumbent configuration reversion request, wherein the non-incumbent configuration reversion request comprises a request to restore access to the first antenna configuration for the plurality of antenna devices to communicate via the wireless network.

19. The computing system of claim 17, wherein detecting occurrence of the spectrum restoration event comprises:
determining that a period of time has passed since either:
(a) the SAS revoked the spectrum access grant for the non-incumbent network entity; or
(b) the incumbent network entity last communicated via the wireless network.

20. A non-transitory computer-readable storage medium that includes executable instructions configured to cause one or more processor devices of a computing system to:
determine that a spectrum access grant for a non-incumbent network entity has been revoked by a Spectrum Access System (SAS) responsive to an utilization of a particular region of frequency spectrum by an incumbent network entity, wherein the spectrum access grant is indicative of a first antenna configuration for one or more antenna devices of the non-incumbent network entity to communicate via a wireless network;
determining a second antenna configuration for the one or more antenna devices to communicate via the wireless network, wherein the second antenna configuration is predicted to cause less interference between the non-incumbent network entity and the incumbent network entity than the first antenna configuration; and
providing a non-incumbent spectrum access request to the SAS, wherein the non-incumbent spectrum access request comprises a request for access to the second antenna configuration for the one or more antenna devices to communicate via the wireless network.
